(19) United States
(12) Patent Application Publication
(10) Pub. No.: US 2013/0254667 A1
(43) Pub. Date: Sep. 26, 2013

(54) METHOD AND SYSTEM FOR ASSESSING USABILITY OF A WEBSITE

(71) Applicants: Jai Ganesh, Bangalore (IN); Ajay Kolhatkar, Pune (IN); Shaurabh Bharti, Jamalpur (IN); Navin Kasa, Rajahmundry (IN); Shrirang Prakash Sahasrabudhe, Pune (IN); Shridhar Karandikar, Pune (IN); Nishtha Srivastava, Lucknow (IN); Varun Joshi, New Delhi (IN); Vijaya Bhaskar Peddinti, Hyderabad (IN); Tarun Prakash Sharma, Dehradun (IN); Mukund Raj, New Delhi (IN)

(72) Inventors: Jai Ganesh, Bangalore (IN); Ajay Kolhatkar, Pune (IN); Shaurabh Bharti, Jamalpur (IN); Navin Kasa, Rajahmundry (IN); Shrirang Prakash Sahasrabudhe, Pune (IN); Shridhar Karandikar, Pune (IN); Nishtha Srivastava, Lucknow (IN); Varun Joshi, New Delhi (IN); Vijaya Bhaskar Peddinti, Hyderabad (IN); Tarun Prakash Sharma, Dehradun (IN); Mukund Raj, New Delhi (IN)

(73) Assignee: INFOSYS LIMITED, Bangalore (IN)

(21) Appl. No.: 13/534,395

(22) Filed: Jun. 27, 2012

(30) Foreign Application Priority Data
Mar. 22, 2012 (IN) 1045/CHE/2012

(51) Int. Cl. G06F 3/0484

(52) U.S. Cl. CPC G06F 3/0484
USPC 715/736

(57) ABSTRACT

The present invention provides a method and system for assessing usability of a website. The method includes scanning at least a portion of the website to be assessed based on a keyword input by a user, where the keyword specifies a structure of an HTML element. The method further includes validating the scanned results with the set of rules and recommendations corresponding to the usability standard and guideline selected by the user and generating a set of reports. The reports include different statistics of the identified usability failure along with the recommendations to improve the web usability requirements.

This application claims the benefit of Indian Patent Application Filing No. 1045/CHE/2012, filed Mar. 22, 2012, which is hereby incorporated by reference in its entirety.

### BACKGROUND

The invention relates generally to the field of web usability. In particular, the present invention relates to a method and system for assessing usability of websites.

The World Wide Web is a vast repository of information that connects people, providing them access to millions of web resources via the Internet. For a company, website is an important product and usability is one of the measurements in website development. As per the International Standards Organization (ISO) definition of usability, website usability is defined as “the extent to which a site can be used by a specified group of users to achieve specified goals with effectiveness, efficiency, and satisfaction in a specified context of use”. The World Wide Web needs to be usable for a large section of the population. Websites need to serve users regardless of their physical, psychological, technological backgrounds, which can be achieved through effective usability design.

However, the usability challenges get intensified in Web 2.0 scenarios since in such cases, the users tend to be content producers and may not be able to produce usable content. Hence there is required a mechanism for enterprises having an online presence to assess, evaluate and remedy issues related to usability of their websites and plan their Web Usability strategies accordingly.

Thus, in light of the foregoing discussion, there is a need for a method and a system to assess usability of the website automatically without human intervention.

### SUMMARY

The present invention relates to a method for assessing the usability of a website. The method includes receiving an address of the website to be assessed for usability from a user and allowing the user to select a usability standard and guideline from among a list of predefined usability standards and guidelines. Each of the predefined usability standards and guidelines is associated with a set of rules and recommendations. The method also includes receiving at least one keyword from the user, wherein the keyword specifies a structure of an HTML element and scanning at least a portion of the website corresponding to the at least one keyword to generate scanned results. The scanned results are validated with the set of rules and recommendations corresponding to the selected usability standard and guideline. A set of reports including a summary report, a detailed report, and an overlay report may be generated. The method further includes allowing the user to input the levels till which the website needs to be scanned for the usability assessment.

The present invention also relates to a system for assessing the usability of a website. The system includes a user interface to receive an address of a website to be assessed for usability from a user and to allow the user to select a usability standard and guideline from a set of predefined usability standards and guidelines. Each of the predefined usability standards and guidelines is associated with a set of rules and recommendations. The user also inputs a keyword which specifies a structure of an HTML element. A scanning engine scans a portion of the website corresponding to the keyword to generate scanned results, where the scanned results are validated with the set of rules and recommendations corresponding to the selected usability standard and guideline by a rules engine. A reporting engine generates a set of reports including a summary report, a detailed report and an overlay report. The detailed report may provide an elaborate description of identified usability failures classified under different priority levels of usability conformance requirements, where the usability failures are mapped with corresponding recommendations to improve the web usability requirements.

The system may be accessed through both Internet and Intranet. The system may also be offered in a SaaS (Software as a Service) mode, where the user pays for the usability assessment based on the usage.

### DRAWINGS

These and other features, aspects, and advantages of the present invention will be better understood when the following detailed description is read with reference to the accompanying drawings in which like characters represent like parts throughout the drawings, wherein:

FIG. 1 shows a flowchart depicting the steps involved in accessing the usability of a website, in accordance with an embodiment of the present invention;

FIG. 2 shows a block diagram representing a system for assessing usability of a website, in accordance with an embodiment of the present invention;

FIG. 3 illustrates a screenshot illustrating a web usability assessment initiation page;

FIG. 4a is a screenshot illustrating a web usability assessment scan confirmation page;

FIG. 4b is a screenshot illustrating a web usability assessment progress page;

FIG. 4c is a screenshot illustrating a web usability assessment report list page;

FIG. 5 illustrates screenshots depicting various statistics generated for a summary report;

FIG. 6 illustrates screenshots depicting various statistics generated for a detailed report;

FIG. 7 illustrates an HTML overlay report; and

FIG. 8 illustrates a generalized example of a computing environment 800.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

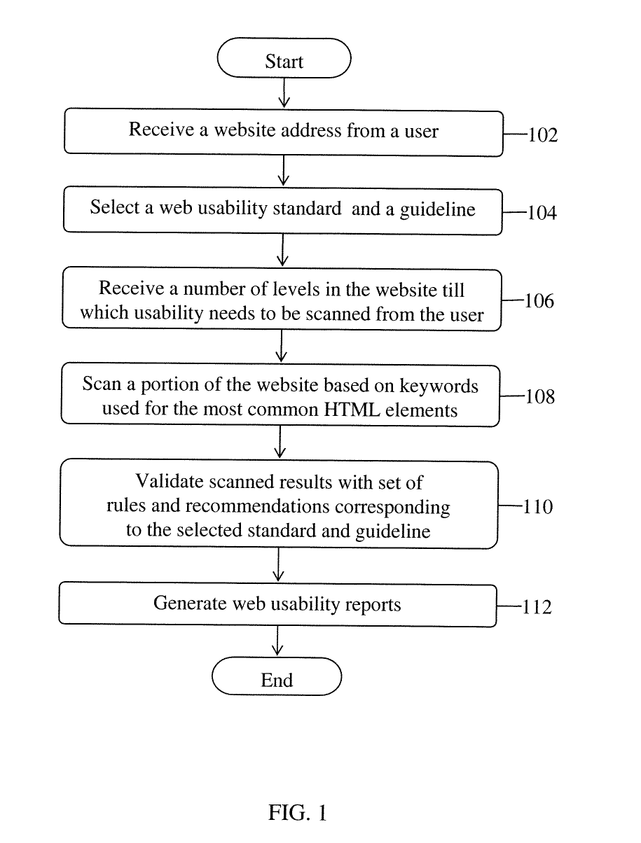

FIG. 1 shows a flowchart depicting the steps involved in assessing the usability of a website, in accordance with an embodiment of the present invention. In various embodiments of the present invention, a user provides an address of a website for assessing the usability of the website at step 102. The address of the website received from the user may be a URL of the website or a location of an HTML document stored in a local file system.

At step 104, the user selects a usability standard and guideline from among a list of predefined usability standards and guidelines. Each usability standard and guideline is associated with a set of rules and recommendations, where the rules and recommendations may be derived from U.S. Department of Health and Human Services, ISO 9241-151, JISC Guidelines, and IST usability guidelines. Each of the predefined usability standards and guidelines comprises a set of usability parameters, where the usability parameters include, but are not limited to, search, user experience, controls, efficiency, layout, navigation, text, links and color.

At step 106, the user inputs a keyword specifying a structure of an HTML element. At step 108, the user inputs a number of levels till which the website needs to be scanned. The levels may include level 1, level 2 and so forth where level 1 refers to the home page of the website and level 2 refers to the links present in the home page. The links on the level 2 webpage may lead to level 3 webpages and so on.

At step 110, a portion of the webpage is scanned based on the keyword to generate scanned results. At step 112, the scanned results are validated with the set of rules and recommendations corresponding to the selected usability standard and guideline.

At step 114, a set of web usability assessment reports are generated. The set of reports includes, but is not limited to, a summary report in a PDF format, a detailed report in PDF and HTML formats and an overlay report in HTML format.

In an embodiment, the summary report provides a high level summary of the usability failures in the assessed website, while the detailed report provides an elaborate description of the usability failures with the corresponding recommendations for improving the usability of the website.

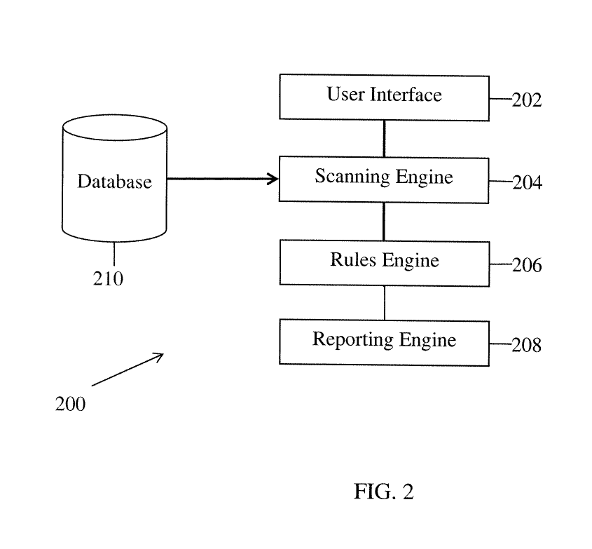

FIG. 2 shows a block diagram representing a system 200 for assessing the usability of the website, in accordance with an embodiment of the present invention. System 200 includes a user interface 202, a scanning engine 204, a rules engine 206, a reporting engine 208 and a database 210.

User interface 202 receives an address of a website to be assessed for usability and a keyword specifying a structure of an HTML element from the user. User interface 202 allows the user to select a usability standard and guideline from a set of predefined usability standards and guidelines, wherein each of the predefined usability standards and guidelines may be associated with a set of rules and recommendations.

User interface 202 also allows the user to input a number of levels till which the website needs to be scanned. In an embodiment, the home page of the website is considered as level 1, and all the links present on the home page will lead to a level 2. Further links on level 2 webpages will lead to a level 3 scan and so on.

Database 210 stores domain specific web usability parameters corresponding to different business domains, where the business domains comprise retail, financial services and insurance. Web usability parameters are classified under search, user experience, controls, efficiency, layout, navigation, text, links and color.

Scanning engine 203 is updated with web usability profiles, web usability accommodation requirements and website analysis results automatically at predefined intervals of time.

In accordance with an embodiment of the present invention, scanning engine 203 scans at least a portion of the website based on keywords, web usability profiles, and web usability accommodation requirements for the most common HTML elements. This makes the scan faster and more easy to report back with the errors. Web usability profiles refer to the usability profiles for which the website should be usable (general all) and specific usability features such as Search, Controls, Efficiency, Layout, Navigation, Text, Links and Color.

Rules engine 206 validates the scanned results with the set of rules and recommendations corresponding to the usability standards and guidelines selected by the user. The user selects a usability standard and guideline from among a list of predefined usability standards and guidelines. Each usability standard and guideline is associated with a set of rules and recommendations, where the rules and recommendations may be derived from U.S. Department of Health and Human Services, ISO 9241-151, JISC Guidelines, and IST usability guidelines. Each of the predefined usability standards and guidelines comprises a set of usability parameters, where the usability parameters include, but are not limited to, search, user experience, controls, efficiency, layout, navigation, text, links and color.

Reporting engine 208 generates a set of reports, which includes, but is not limited to, a summary report, a detailed report and an overlay report. In an embodiment, the summary report may be in a PDF format, the detailed report may be in both PDF and HTML formats, while the overlay report is in an HTML format.

It should be noted that system 200 can be accessed through both Internet and Intranet. Further, system 200 may also be offered in a SaaS (Software as a Service) mode, where the user pays for usability assessment based on the usage.

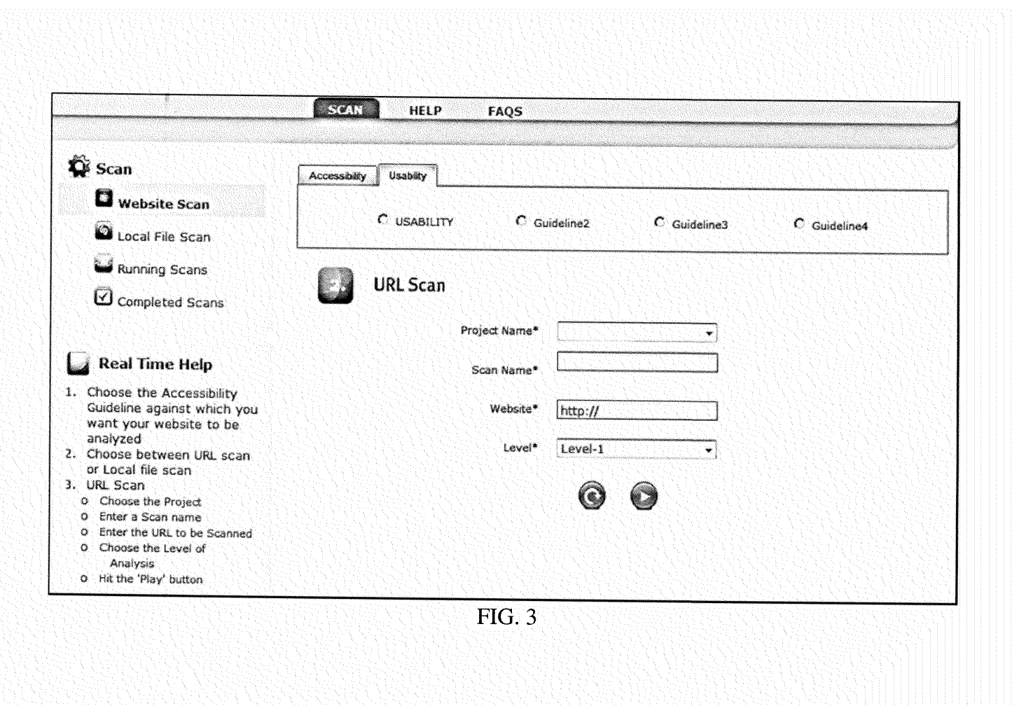

FIG. 3 is a screenshot illustrating a web usability assessment initiation page, in accordance with an embodiment of the present invention. As shown in the figure, the initiation page has provisions to enable the user to input the address of the website to be assessed, the levels till which the website needs to be scanned, and to select the usability standard and guideline.

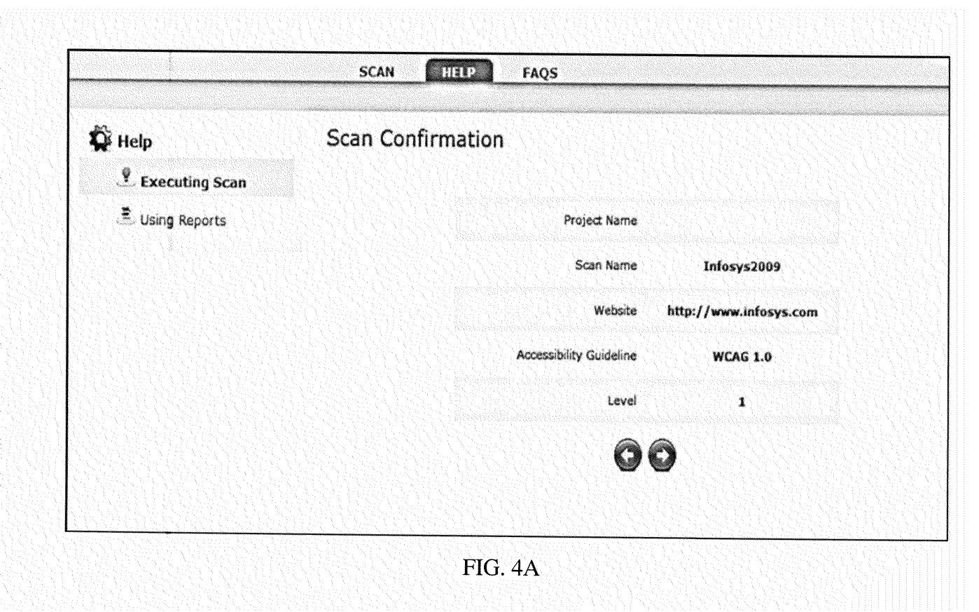

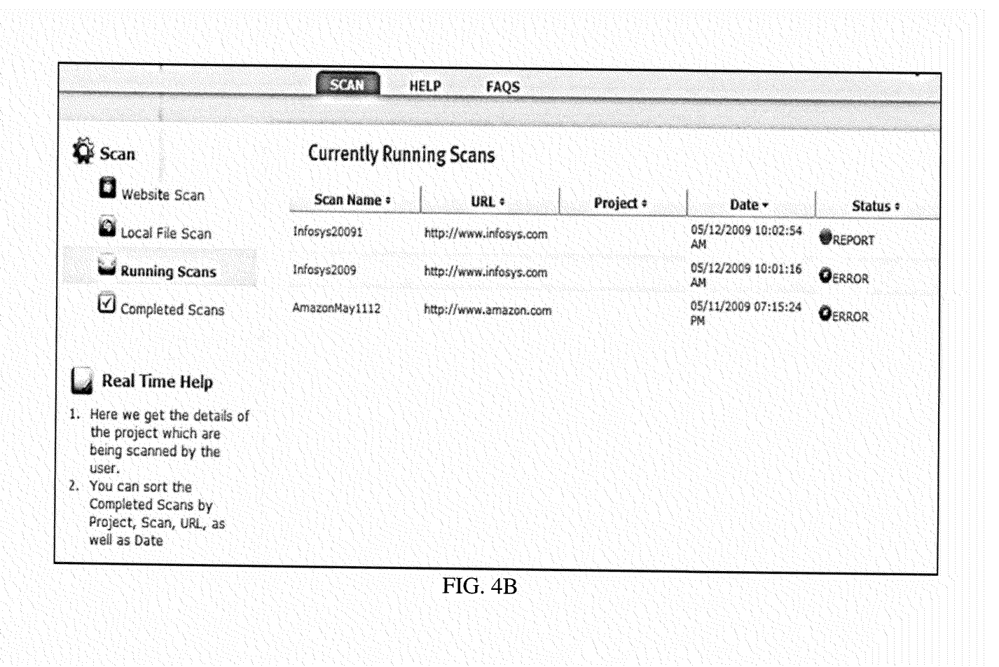

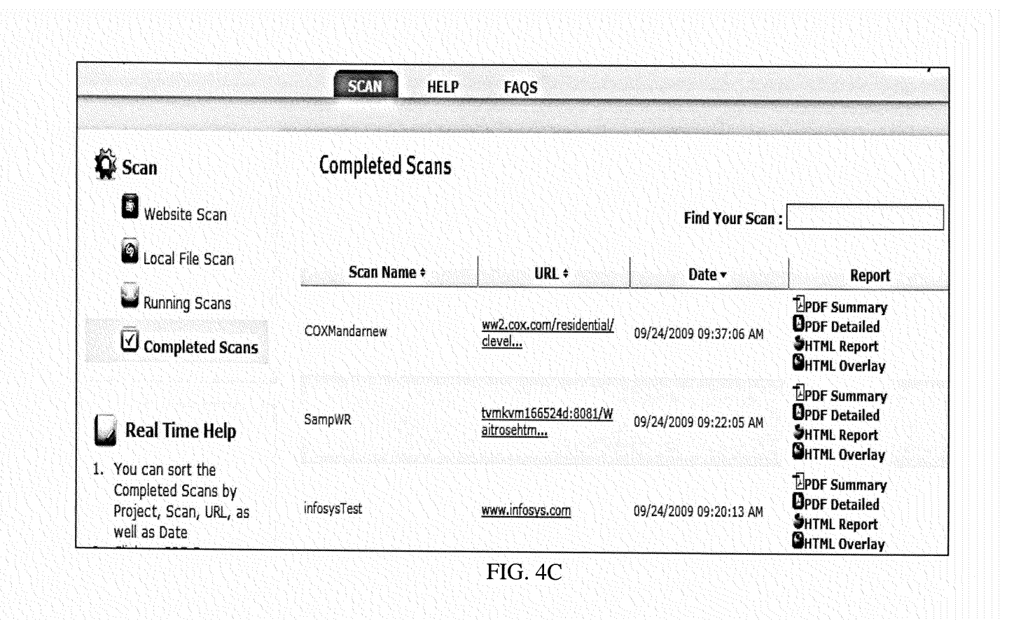

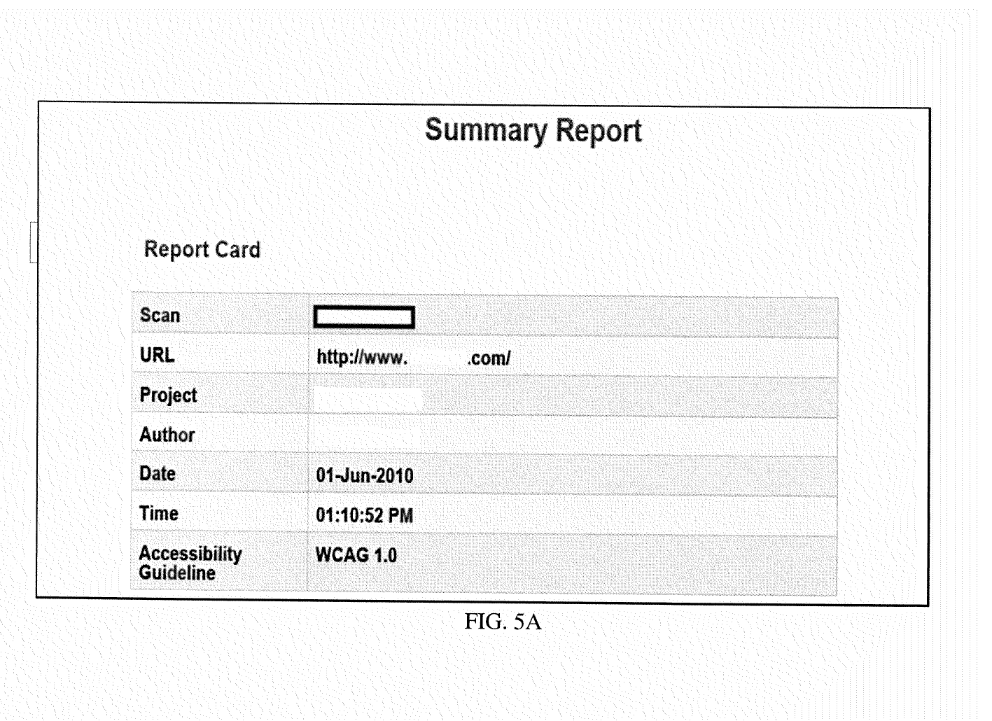

FIG. 4A through 4C refer to screenshots illustrating various stages in a web usability assessment such as scan confirmation stage, assessment progress stage, and assessment reporting stage, in accordance with an embodiment of the present invention.

### Web Accessibility Reports

In an embodiment, the summary report provides a high level statistics summary of the number of usability failures in the assessed website in a PDF format. The detailed report in PDF and HTML formats provide a description of the usability failures with the corresponding recommendations for improving the usability of the website.

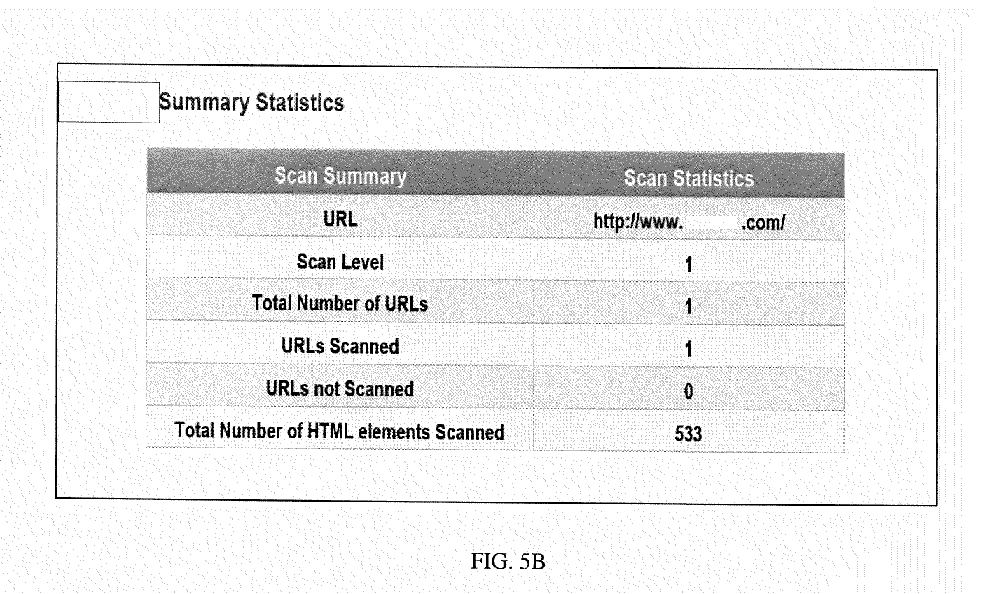

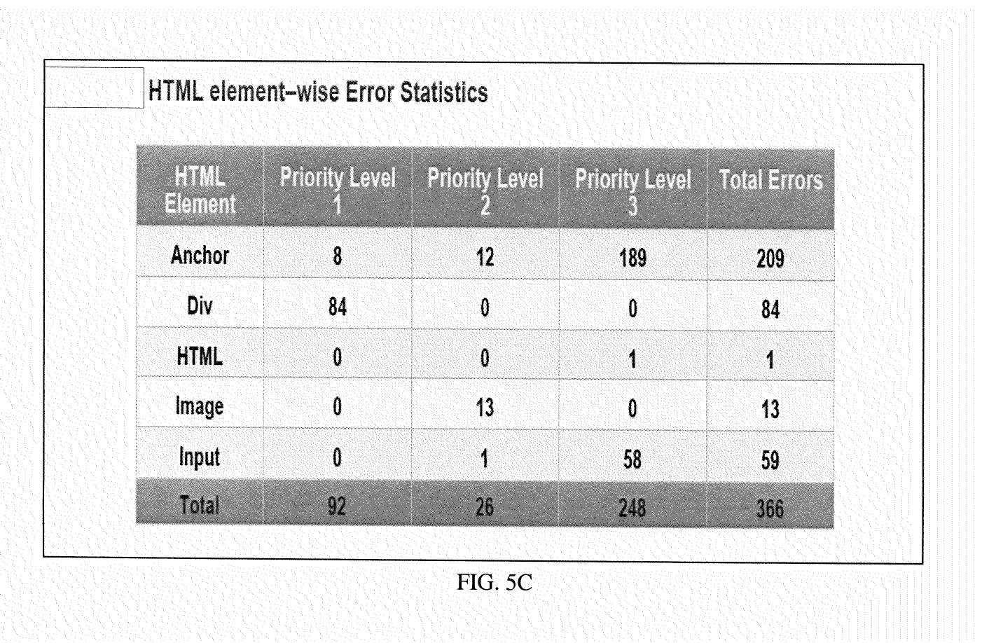

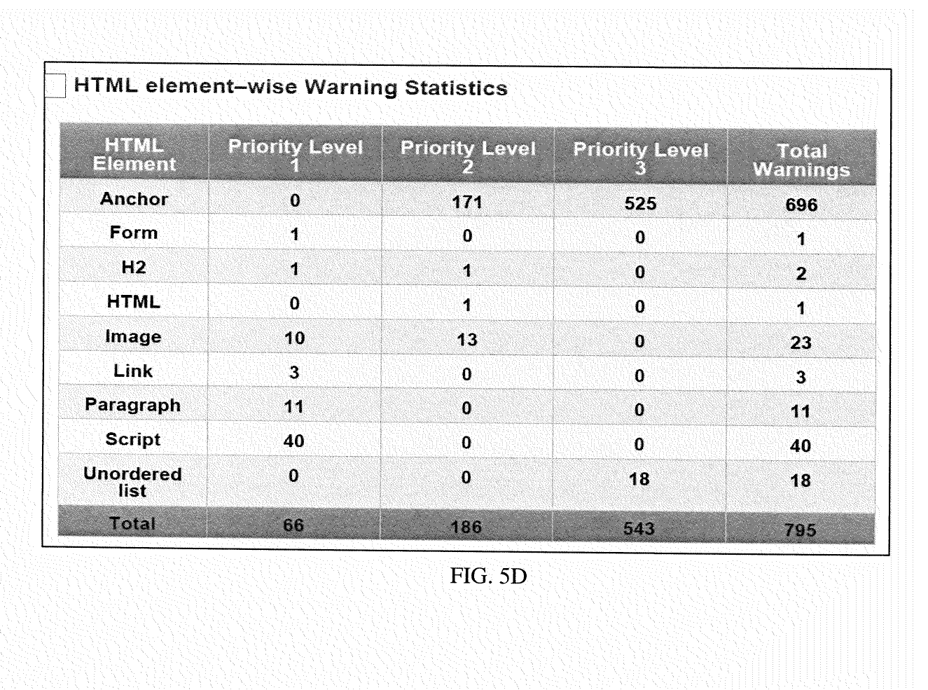

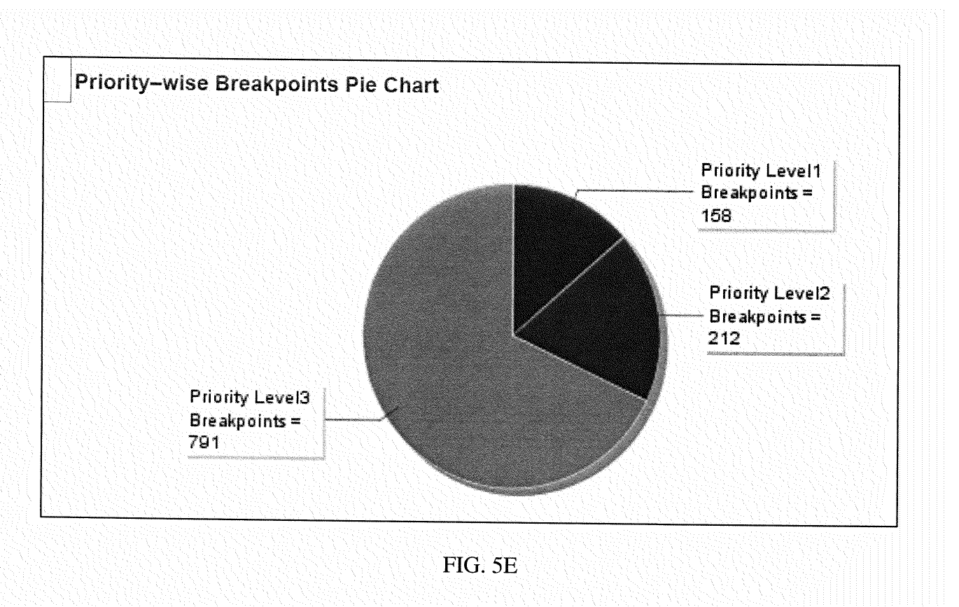

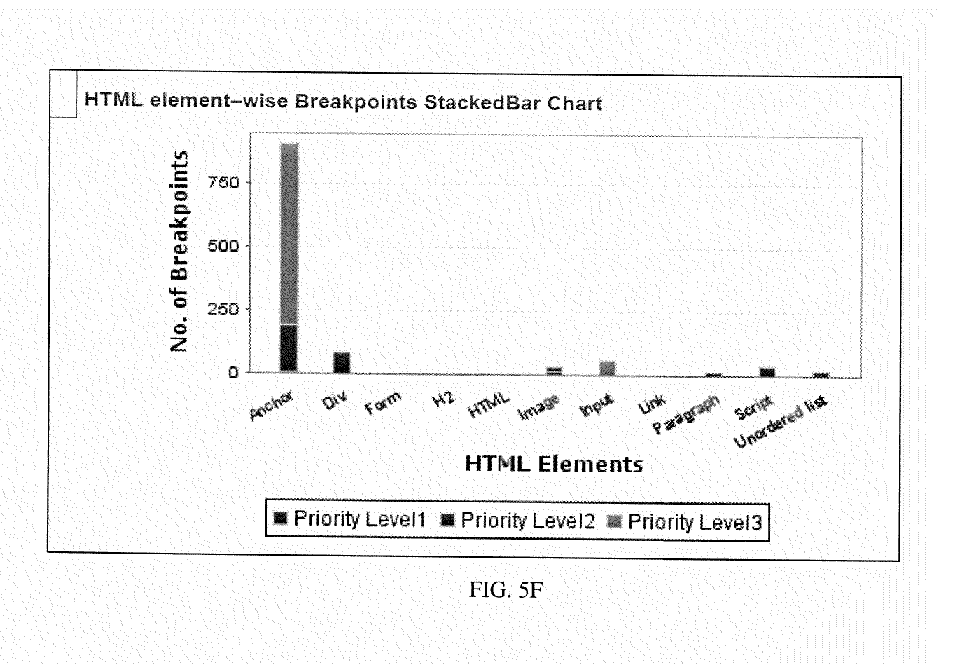

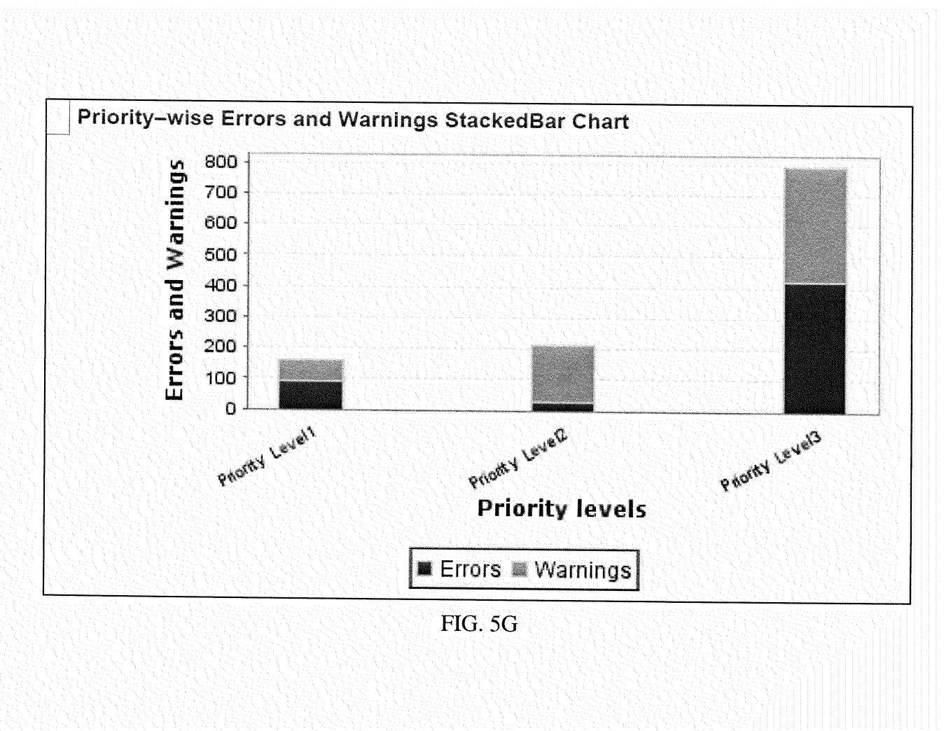

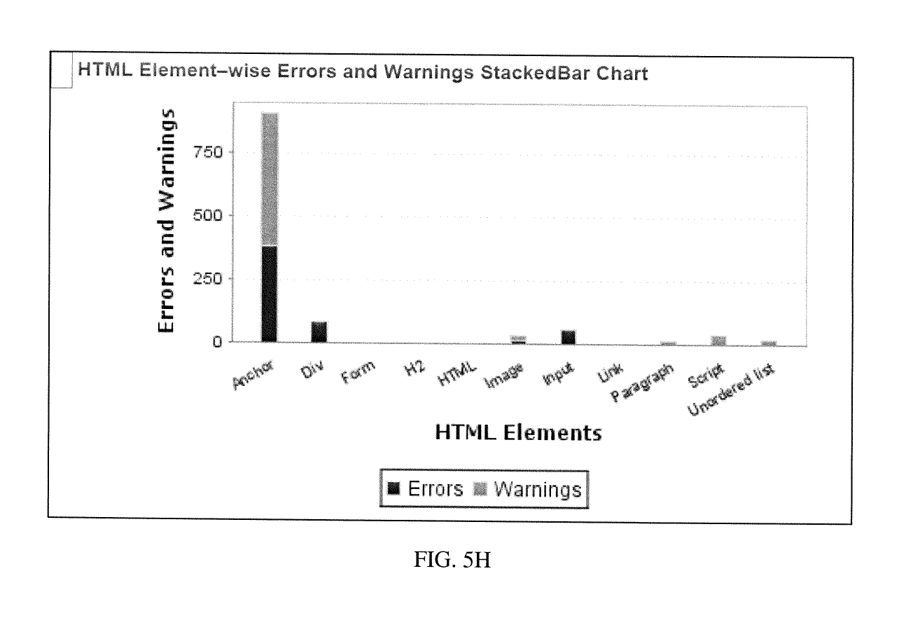

FIG. 5A through 5I refer to screenshots depicting various statistics generated for a summary report in the web usability assessment, in accordance with an embodiment of the present invention. In particular, FIG. 5A illustrates a report card which specifies the date & time at which the web usability assessment is performed and also specifies the usability guideline selected for the assessment.

FIG. 5B illustrates a summary of statistics such as the scan level, URLs scanned and URLs not scanned and the total number of HTML elements scanned during the web usability assessment.

FIGS. 5C and 5D illustrate the errors and warnings identified and tabulated against different HTML elements and the corresponding priority levels. The priority levels refer to the usability conformance requirements, in which priority level 1 refers to the basic requirements for usability conformance, priority level 2 refers to the major requirements for the usability conformance and the priority level 3 refers to the critical requirements for the usability conformance.

FIG. 5E illustrates a pie chart depicting the proportion of the breakpoints identified across different priority levels and FIG. 5F illustrates a stacked bar chart depicting the number of breakpoints identified across different HTML elements, where the different stacks in the bar refer to the priority levels.

FIG. 5G illustrates a stacked bar chart depicting the number of error and warnings identified across different priority levels and FIG. 5H illustrates a stacked bar chart depicting the number of errors and warnings identified across different HTML elements.

FIG. 5I illustrates a bar chart depicting the number of breakpoints identified across different HTML elements.

In accordance with an embodiment of the present invention, the different statistics generated for the summary report provides the website administrator direct visibility into the most significant errors in the assessed website thereby allowing prioritization of the remediation activity.

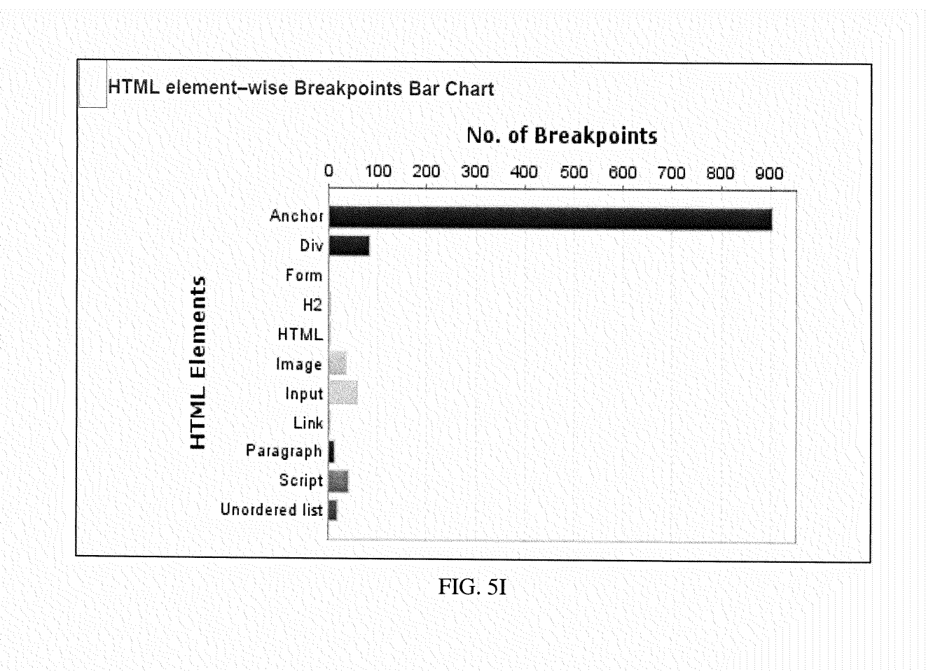

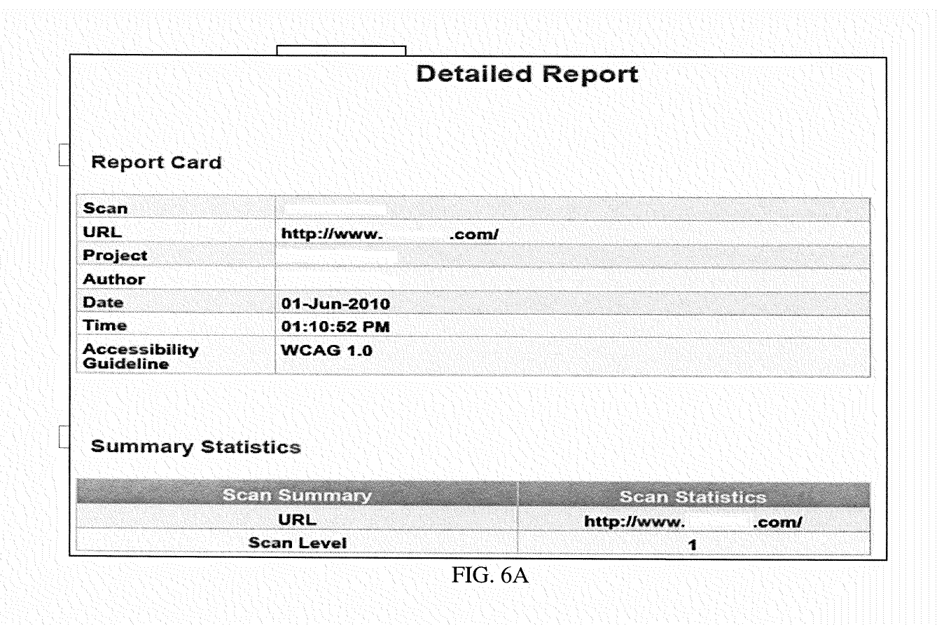

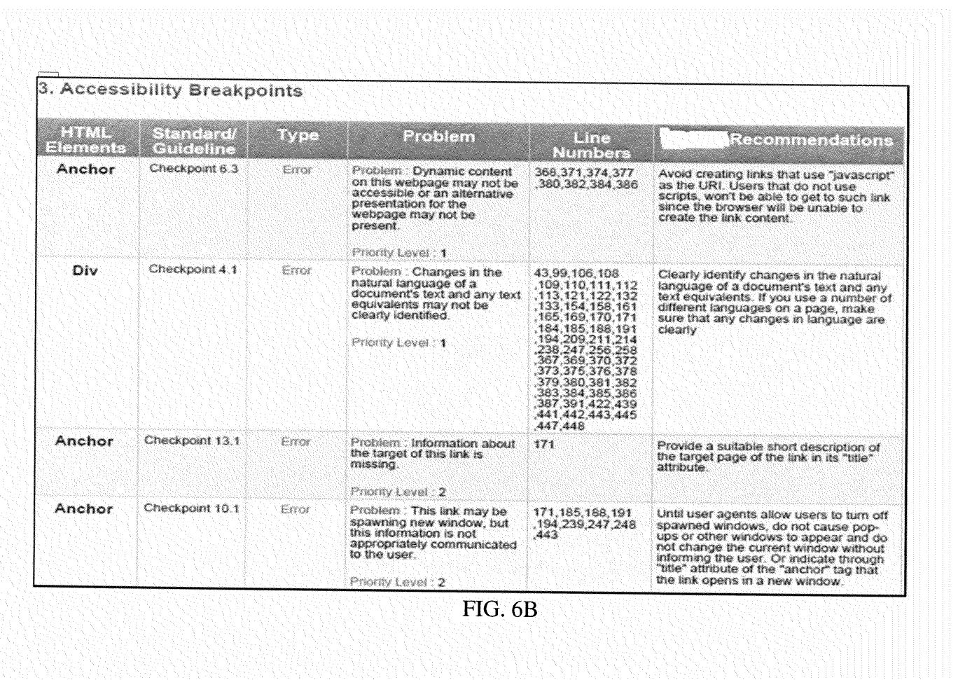

FIGS. 6A and 6B illustrate screenshots depicting the various statistics generated for a detailed report. In particular, FIG. 6B refers to a detailed description of the usability failures identified during the assessment. The report consists of a table of web usability assessment information, where the first column specifies the HTML element and the second column specifies the standard/guideline against which the HTML element is validated. The third column in the report specifies the type of web usability failure, that is, whether the identified failure is an error or a warning. The fourth column includes an elaborate description of the identified usability failure with the priority level information. Recommendations to improve the usability of the website may be provided in the last column of the table for each of the identified web usability failure. The table may also include information such as the line numbers where the failure is identified. It should be noted that the details of the report mentioned above are only for exemplary purposes and that the table may include additional or alternative details related to the report.

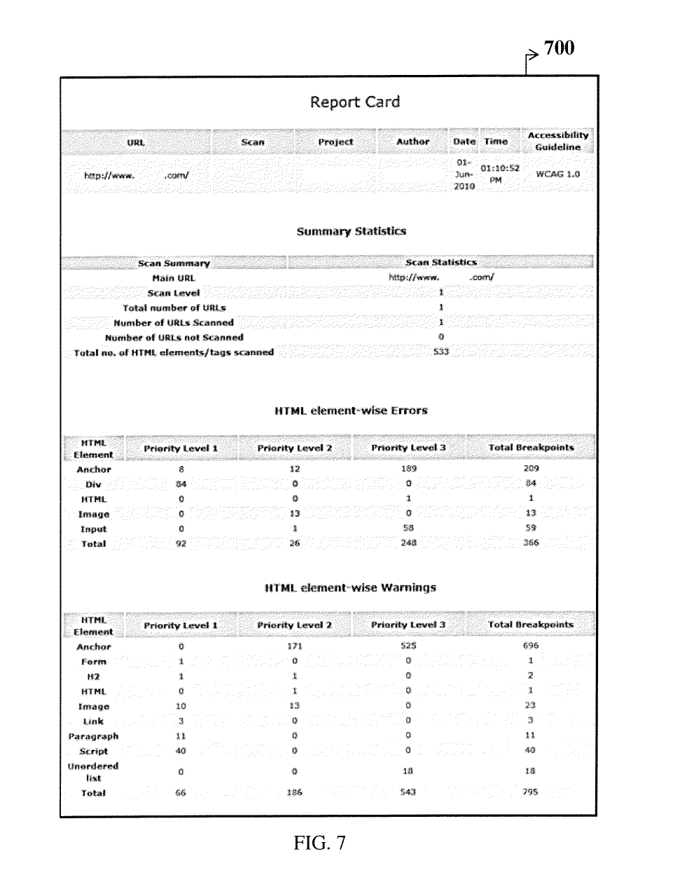

FIG. 7 refers to an HTML overlay report, which is an overlay on top of the website that is assessed and opens in a separate window, in accordance with an embodiment of the present invention. The overlay report illustrates markings on the error areas of the website and a mouse-over the error area enables the user to see the usability failure/violation as well as the recommendations provided to the violation.

### Exemplary Computing Environment

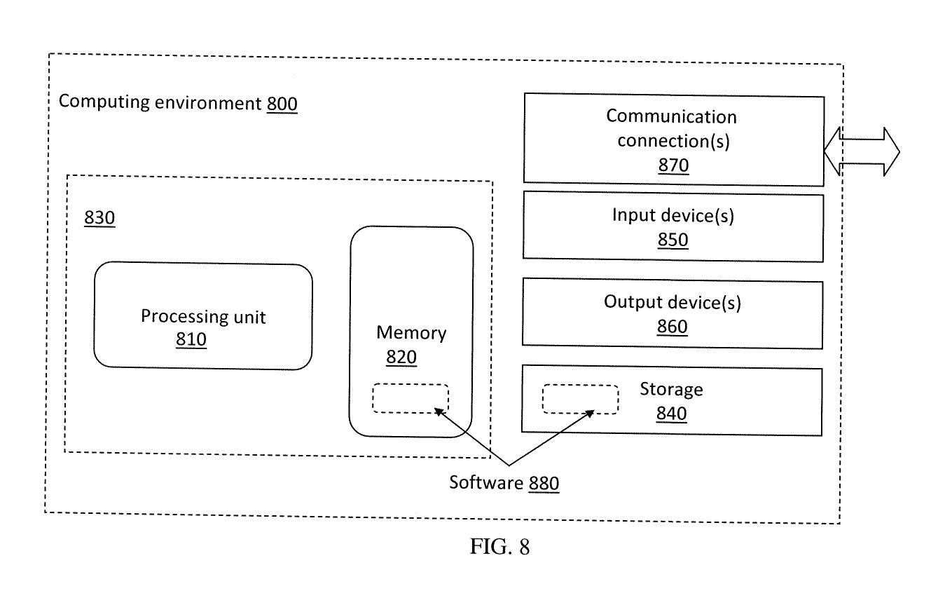

One or more of the above-described techniques can be implemented in or involve one or more computer systems. FIG. 8 illustrates a generalized example of a computing environment 800. The computing environment 800 is not intended to suggest any limitation as to scope of use or functionality of described embodiments.

With reference to FIG. 8, the computing environment 800 includes at least one processing unit 810 and memory 820. In FIG. 8, this most basic configuration 830 is included within a dashed line. The processing unit 810 executes computer-executable instructions and may be a real or a virtual processor. In a multi-processing system, multiple processing units execute computer-executable instructions to increase processing power. The memory 820 may be volatile memory (e.g., registers, cache, RAM), non-volatile memory (e.g., ROM, EEPROM, flash memory, etc.), or some combination of the two. In some embodiments, the memory 820 stores software 880 implementing described techniques.

A computing environment may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The storage 840 may be removable or non-removable, and includes magnetic disks, magnetic tapes or cassettes, CD-ROMs, CD-RWs, DVDs, or any other medium which can be used to store information and which can be accessed within the computing environment 800. In some embodiments, the storage 840 stores instructions for the software 880.

The input device(s) 850 may be a touch input device such as a keyboard, mouse, pen, trackball, touch screen, or game controller, a voice input device, a scanning device, a digital camera, or another device that provides input to the computing environment 800. The output device(s) 860 may be a display, printer, speaker, or another device that provides output from the computing environment 800.

The communication connection(s) 870 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 800, computer-readable media include memory 820, storage 840, communication media, and combinations of any of the above.

The system and method enables the benchmarking of usability of website features across different websites. The system and method provides an initial understanding of current web usability accommodations and benchmark the same against a peer group and plan the future course of action. The system and method is useful for enterprises having an online presence to assess and remedy issues related to the usability of their websites.

The system and method is also very useful for websites which needs to provide high level of usability for end users, hence providing a very large business opportunity as a vast majority of websites score low on usability.

Implementations can be described in the general context of computer-readable media. Computer-readable media are any available media that can be accessed within a computing environment. By way of example, and not limitation, within the computing environment, computer-readable media include memory, storage, communication media, and combinations of any of the above.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method for assessing usability of a website, the method comprising:
receiving an address of the website to be assessed for usability from a user;
allowing the user to select a usability standard and guideline from among a list of predefined usability standards and guidelines, wherein each of the predefined usability standards and guidelines is associated with a set of rules and recommendations;
scanning at least a portion of the website based on one or more keywords to generate one or more scanned results;
validating the one or more scanned results with the set of rules and recommendations corresponding to the selected usability standard and guideline; and
generating a set of reports, wherein the set of reports comprises a summary report, a detailed report, or an overlay report.

2. The method according to claim 1 further comprising allowing the user to input a number of levels at which the usability of the website is to be assessed.

3. The method according to claim 2, wherein the number of levels comprises a home page of the website, the home page of the website and a plurality of links from the home page, or the home page of the website, a plurality of links from the homepage, and a plurality of further links.

4. The method according to claim 1, wherein each of the predefined usability standards and guidelines comprises a set of usability parameters wherein the usability parameters comprise a search, a user experience, one or more controls, an efficiency, a layout, a navigation, a text, one or more links or a color.

5. The method according to claim 1, wherein the summary report provides a high level summary of one or more usability failures in the assessed website in a PDF format.

6. The method according to claim 1, wherein the detailed report in PDF and HTML formats provides a description of one or more usability failures with one or more corresponding recommendations for improving the usability of the website.

7. The method according to claim 6, wherein the one or more usability failures are classified under a priority level based on a criticality of the one or more usability failures, wherein a priority level 1 comprises one or more basic requirements for a usability conformance, a priority level 2 comprises one or more major requirements for usability conformance and a priority level 3 comprises one or more critical requirements for usability conformance.

8. A system for assessing usability of a website, the system comprising:
a user interface configured to:
receive an address of the website to be assessed for usability from a user;
allow the user to select a usability standard and guideline from a set of predefined usability standards and guidelines, wherein each of the predefined usability standards and guidelines is associated with a set of rules and recommendations; and
a scanning engine configured to scan at least a portion of the website based one or more keywords to generate one or more scanned results;
a rules engine configured to validate the one or more scanned results with the set of rules and recommendations corresponding to the selected usability standard and guideline; and
a reporting engine configured to generate a set of reports, wherein the set of reports comprises a summary report, a detailed report or an overlay report.

9. The system according to claim 8, wherein the user interface is further configured to allow the user to input a number of levels at which the usability of the website is to be assessed.

10. The system according to claim 8, further comprising a database to store one ore more domain specific parameters corresponding to one or more business domains wherein the business domains comprise a retail domain, a financial services domain, or an insurance domain.

11. The system according to claim 8, wherein each of the predefined usability standards and guidelines comprises a set of usability parameters wherein the usability parameters comprise a search, a user experience, one or more controls, an efficiency, a layout, a navigation, a text, one or more links or a color.

12. The system according to claim 8, wherein the scanning engine is updated with one or more web usability profiles, one or more web usability accommodation requirements or an analysis of one or more websites automatically at one or more predefined intervals of time.

13. The system according to claim 12, wherein the scanning engine scans the at least one portion of the website based on the one or more of web usability profiles, the one or more web usability accommodation requirements, an analysis of the one or more websites, or one or more domain specific parameters.

14. The system according to claim 8, wherein the summary report provides one or more usability failures in the assessed website in a PDF format.

15. The system according to claim 8, wherein the detailed report, in PDF and HTML formats, provides a description of one or more usability failures at one or more priority levels with one or more corresponding recommendations to improve the usability of the website.

16. The system according to claim 15, wherein the one or more usability failures are classified under a priority level based on a criticality of the one or more usability failures, wherein a priority level 1 comprises one or more basic requirements for a usability conformance, a priority level 2 comprises one or more major requirements for usability conformance and a priority level 3 comprises one or more critical requirements for usability conformance.

17. A computer program product for use with a computer, the computer program product comprising a non-transitory computer usable medium having a computer readable program code embodied therein for assessing usability of a website, the computer readable program code storing a set of instructions configured for:
receiving an address of the website to be assessed for usability from a user;
allowing the user to select a usability standard and guideline from among a list of predefined usability standards and guidelines, wherein each of the predefined usability standards and guidelines is associated with a set of rules and recommendations;
scanning at least a portion of the website based on one or more keywords to generate one or more scanned results;
validating the one or more scanned results with the set of rules and recommendations corresponding to the selected usability standard and guideline; and
generating a set of reports, wherein the set of reports comprises a summary report, a detailed report, or an overlay report.

18. The computer program product of claim 17, wherein further comprising instructions for allowing the user to input a number of levels at which the usability of the website is to be assessed.

19. The computer program product of claim 17, wherein each of the predefined usability standards and guidelines comprises a set of usability parameters wherein the usability parameters comprise a search, a user experience, one or more controls, an efficiency, a layout, a navigation, a text, one or more links or a color.

20. The computer program product of claim 17, wherein the summary report provides a high level summary of one or more usability failures in the assessed website in a PDF format.

21. The computer program product according to claim 17, wherein the detailed report, in PDF and HTML formats, provides a description of one or more usability failures with one or more corresponding recommendations for improving the usability of the website.

22. The computer program product according to claim 17, further comprising instructions for classifying one or more usability failures under a priority level based on a criticality of the one or more usability failures wherein the priority level 1 comprises one or more basic requirements for a usability conformance, a priority level 2 comprises one or more major requirements for usability conformance and a priority level 3 comprises one or more critical requirements for usability conformance.
